(19) United States
(12) Patent Application Publication
(10) Pub. No.: US 2013/0266686 A1
(43) Pub. Date: Oct. 10, 2013

(54) METHOD FOR DESALTING ANIMAL TISSUE

(71) Applicant: Marnix Rogier Morskate, Veghel (NL)

(72) Inventor: Marnix Rogier Morskate, Veghel (NL)

(73) Assignee: VION INGREDIENTS NEDERLAND (HOLDING) B.V., Best (NL)

(21) Appl. No.: 13/877,590

(22) PCT Filed: Nov. 23, 2011
(86) PCT No.: PCT/EP11/70758

§ 371 Date: Apr. 3, 2013

(30) Foreign Application Priority Data
Nov. 23, 2010 (EP) 10306288.1

(51) Int. Cl. A23K 1/00; A23K 1/18

(52) U.S. Cl. CPC A23K 1/007; A23K 1/1893
USPC 426/2; 426/56; 426/645

(57) ABSTRACT

The present invention relates to a method for desalting tissue originating from animals. In particular, the present invention provides a method for desalting mucosa tissue, notably mucosa tissue originating from bovine or porcine. The invention also provides a method for preparing animal feed supplement or additive enriched in nutritional elements readily available to the animal, in particular to the young animal, for example young piglets, chickens, calves or aqua species. The invention also provides a low-salt content or a salt-free animal feed supplement and a feeding or growing method using the same.

The present invention relates to a method for desalting tissue originating from animals. In particular, the present invention provides a method for desalting mucosa tissue, notably mucosa tissue originating from bovine or porcine.

The invention also provides a method for preparing an animal feed supplement or additive enriched in nutritional elements readily available to the animal, in particular to the young animal, for example young piglets, chickens, calves or aqua species.

The invention also provides a low-salt content or a salt-free animal feed supplement and a feeding or growing method using the same.]

As an example, in the producing pork industry, an important economic factor is the time required to raise pigs following weaning to a marketable weight. The process of weaning, especially early weaning (generally between 10 and 25 days of age, in particular 18 or 21 days), produces challenges that the young pigs have not previously experienced. These challenges include, among other things, an abrupt change in diet, usually from sow's milk to grain-based feeds. During the post-weaning period, pigs typically have a limited opportunity to digest anything but sow's milk before being abruptly introduced to feed other than sow's milk, such as grain-based feeds. Besides being unfamiliar with the new feed, the young pigs must also adapt to a new social structure where the pigs are not solely reliant on their sows for nourishment. When these two circumstances occur simultaneously, nutritional intake by the young pigs is typically disrupted, which may reduce the growth rate of the young pigs and also may increase the mortality rate of the young, post-weaned pigs.

A number of feed additives have been employed as feed supplements for young pigs. For example in U.S. Pat. No. 6,783,777, there is described a method consisting in providing to post-weaned piglets a feed coated with a liquid digest that is prepared by enzymatically processing a nutritional component and then applying the resulting liquid digest onto a feed substance to form the swine feed.

The coated feed is supposed to increase the apparent palatability of the feed allowing an increased daily feed intake by the pigs and an increased average daily gain by young post-weaned piglets. The coated feed is prepared from components like proteinaceous materials, fatty materials, carbohydrate-containing materials or any combination thereof. However, in the liquid digest used to coat the animal feed remains important amounts of ashes, mainly constituted by salts or solid and crystalline substances, in amounts from 2.5 to 9% at least.

The presence of these ashes in the liquid digest certainly prevents the use of large amounts of such in coating the animal feed; the liquid digest amount is preferably limited to 3% of the coated animal feed. In addition, high contents of such ash or salt in the animal feed can lead to diarrhoea, notably in piglets.

Another approach in feed additive for young pigs includes a protein hydrolysate that is derived from processing of animal tissue, for example from porcine mucosa and intestinal portions. High salt content in feed additive originating from processed animal tissue limits its application, in particular limits its application dosage.

Even if the existing means appear to provide some results, there still remains a need to provide improved animal feed supplement or additive enriched in nutritional elements readily available to the animal, notably to the young animal. In particular, it remains an important need to provide animal feed supplement or additive enriched in nutritional elements readily available to the animal that is substantially free of salt or largely improved in reduced salt content.

Indeed, due to high salt content mucosa tissue that has been enzymatically processed results in a protein hydrolysate that can be mixed only at limited concentrations in the final feedstock provided to the animal.

However with the continuous development of the mucosa based products in the animal feed industry, the high ash content, that is believed to be almost exclusively caused by salts, limits the value and interest in this source of proteins required by growing animals.

Some attempts to reduce the salt content have used some ultra- or nano-filtration techniques. These techniques are not considered as satisfactory for various reasons, including a lack of selectivity or even an unsatisfactory separation rate leading to an overall limited yield resulting to up to 80% of the protein containing product being lost with the separated salts.

Precipitation with calcium chloride has also been used in order to transform the salts in a precipitate. This technique also lacks some selectivity and efficiency.

The use of ion-exchange resins to separate the salts from the protein containing products has also been experienced with a final yield that is low since a major part of the proteins or amino-acids were adsorbed by the resin hence resulting in product loss.

The economical profile of these techniques, notably compared with the overall recovery rate, does not appear to be satisfactory.

In addition, the high salt content mucosa tissue tends to form lumps resulting in operational problems during processing of the material hence impacting the final efficiency of the existing techniques.

From JP-60-133854 is known a method for producing seasoning that includes a desalting step based on using electro-dialysis technique. This method uses finely crushed muscle, head, bone, shell of fresh or frozen animal, fish, shellfish or crustacean as raw materials wherein 5-30% metal salt is added to control deterioration of food due to microorganisms. Further to liquefaction and decomposition of proteins carried out by self digestive enzymes of the raw materials, enzymes produced by microorganisms such as aerobic bacteria and yeast or by enzymes that are added according to need, sterilization and deactivation of enzyme is carried out by heating at 95-110° C. The salt and metal are then removed by electro-dialysis using an ion-exchange membrane in order to yield a seasoning. However, this document does not address the production of animal feed supplement or additive.

From U.S. Pat. No. 6,051,687 is known a method for removing sulphite or sulphate from a liquid protein hydrolysate by chemical treatment leading to precipitation followed by removing of the precipitated sulphite and sulphate. However, this precipitation technique does not prove to be suitable nor efficient for a large variety of salts other than sulphite and sulphate. In addition, this method requires previous removing of fatty components from the starting liquid protein hydrolysate by acid treatment and separation. A second step consists in precipitating sulphite and sulphate by adding calcium anions and removing the precipitate. In addition to the precipitation of sulphite and sulphate, all or part of the protein content precipitates simultaneously thus reducing the amount of protein that is recovered. Efficiency and selectivity of methods based on precipitation thus appears to be problematic.

In WO-2004/00035, there is disclosed an animal feed comprising mucosa by-products. This document does not address desalting such by-products by electro-dialysis.

The method disclosed in U.S. Pat. No. 5,607,840 does not refer either to the implementation of electro-dialysis in desalting mucosa by-products. The method disclosed in this patent does not allow important or substantial removing of preservative salts from the final animal feed.

The purpose of the present invention is thus to provide a method for desalting animal tissue, in particular mucosa tissue originating from bovine or porcine. The method according to the invention allows substantially desalting mucosa tissue that has been enzymatically processed or hydrolyzed.

The invention also provides an animal feed supplement or additive in the form of a composition that is enriched in nutritional elements readily available to the animal and that is substantially free of salt or largely improved in reduced salt content.

The invention also provides a method for feeding fish or animal, in particular young animals notably piglets, with an improved animal feed supplement or additive.

The invention thus allows to partially or totally solve the problems of the prior art. The methods and composition according to the present invention thus provide a solution to the outstanding need that will enhance the economic viability of meat producers, in particular of pork producers.

The method according to the invention allows the preparation of a supplement or additive that is compliant with current regulation, in particular with EU regulation 808/2003 whereby the resulting hydrolyzed product has a molecular weight that is far below 10,000 Dalton. This renders it easier to digest by the fed animals but more important renders it safe with regard to the PrP-sc prion associated with TSE/BSE diseases.

The present invention thus provides a method for the preparation of an animal feed supplement by electro-dialysis desalting of a porcine mucosa protein hydrolysate.

In particular, the present invention provides a method for the preparation of an animal feed supplement by electro-dialysis desalting of a porcine mucosa protein hydrolysate whereby the animal feed supplement consists in the a porcine mucosa protein hydrolysate resulting from electro-dialysis desalting.

According to the invention, the porcine mucosa protein hydrolysate normally consists in protein hydrolysate of porcine mucosa, pig protein hydrolysate, hydrolyzed porcine protein, hydrolyzed porcine mucosa protein or hydrolyzed mucosa proteins of porcine origin. According to the present invention, the starting protein hydrolysate is generally prepared by methods known in the art. Such a protein hydrolysate is a common by-product of the extraction of the blood anti-coagulate heparin from porcine hash gut or intestinal mucosa. An aqueous solution comprising the mucosa from the livestock waste or by-products is usually chemically, either by acid or alkaline treatment, or enzymatically hydrolyzed, by protease for example. The heparin is then extracted from the hydrolyzed mucosa by techniques known in the art, such as selective sorption using an ionic exchange resin.

For example, in a slaughterhouse the mucosal tissue of intestines is separated from the outer lining, the mucosa tissue is recovered and usually salted, notably with sodium chloride, in order to prevent protein decay and with sodium meta-bisulphite for preservation purposes; sodium meta-bisulphite being known to yield sulphite and sulphate. Sorption efficiency is also generally improved. At this stage, the mucosa can be processed in order to separate heparin that is resulting from an enzymatic treatment of mucosa. The mucosa tissue is thus first hydrolyzed then heparin is extracted. The mucosa tissue also containing proteins is decomposed under the action of protease enzymes thereby releasing heparin from the protein matrix. After extraction of heparin from the digested mucosa, the resulting mixture after hydrolysis merely consists of protein components of lower molecular weights. Typically, such a mixture usually comprises proteins in residual or reduced amounts and principally peptides, notably poly-peptides, oligo-peptides and di- or tri-peptides, and free amino acids that have a lower size, lower molecular size or molecular weight.

The relative protein amounts in each components of the hydrolysate can vary widely. An example of such a mixture can be 10% of polypeptides, 10% of oligo-peptides, 40% of di- and tri-peptides and 40% of free amino acids. In this case, 80% of the components have a size equal or less than 3 peptides. This renders it ideal to be digested by the animals, in particular weaning animals.

The enzymatically-processed mucosa can be centrifuged in order to separate the fatty components and other components that can have a negative impact on the downstream process, and then filtered in order to separate its protein components depending on their respective molecular weights. A typical separation can allow recovering the hydrolyzed proteins or parts thereof having a molecular weight of less than 10,000 Dalton. The parts having a molecular weight of more than 10,000 Dalton can be further enzymatically-processed or processed in standard rendering plants. The filtration step can consist in an ultra-filtration, notably an ultra-filtration on a 10 kD membrane.

The addition of conservative salts to mucosa tissue at the slaughterhouse is finally concentrated up to 220-fold further to the enzymatic processing and purification steps.

The resulting protein hydrolysate thus requires to be desalted by electro-dialysis according to the method according to the invention.

According to the method of the invention, the starting material is possibly concentrated before the electro-dialysis step. The concentration before electro-dialysis normally amounts up to a maximum of 20% of dry matter. Further concentration before drying with air is preferred from an energy efficiency point of view since air drying is energy consuming. Drying the mucosa tissue hydrolysate in order to reduce its water content by 50% is advantageous.

Further to the desalting step, a major part of the water or moisture content of the resulting product can be eliminated by evaporation, drying or both.

For the method according to the invention, the salts that are eliminated can be selected in the list consisting of conservation salts and notably sodium, potassium, sulphite and sulphate salts, for example sodium chloride, sodium meta-bisulphite that is a broadly used preservative salt.

According to the invention, the salt content can be reduced by 50%, preferably by 80% or even by substantially 100%.

Electro-dialysis (ED) is a known technique that is used to transport salt ions from one solution through ion-exchange membranes to another solution under the influence of an applied electric potential difference. This is normally realised in an electro-dialysis cell. The cell usually consists of a feed or diluate compartment and a concentrate or brine compartment formed by an anion exchange membrane and a cation exchange membrane placed between two electrodes. In almost all practical electro-dialysis processes, multiple electro-dialysis cells are arranged into a configuration called an electro-dialysis stack, with alternating anion and cation exchange membranes forming the multiple electro-dialysis cells. The overall result of the electro-dialysis process is an ion concentration increase in the concentrate stream with a depletion of ions in the diluate solution feed stream due to the combined action of the current action and the alternate anion and cation exchange membranes.

For the method according to the invention, the electro-dialysis technique is carried out in order to separate salts from the mucosa tissue hydrolysate. Electro-dialysis requires that a solution is conducting electricity. Within the method according to the invention, this is rendered possible due to the presence of the salts that possess a very high electric conductivity.

For the method according to the invention, the electro-dialysis parameters can be selected by the person skilled in the art, in particular the current density, the cell voltage, the current efficiency, the diluate and concentrate concentrations.

The maximum voltage can vary widely in particular from 0.8 to 2 V/cell; the minimum conductivity that can be considered is around 0.5 mS/cm; the temperature can also vary, for example between 10 and 50° C., preferably below 40° C.; pH can also be adapted by any treatment available to the person skilled in the art, for example to optimise or prevent amino-acid losses.

The size of the cells can also vary widely, for example with an effective cell size of from 0.1 m² to 500 m².

According to the invention, the electro-dialysis step can be operated in a continuous production process or in a batch production process.

The invention thus provides an animal feed supplement originating from enzymatically processed mucosa tissue, or mucosa tissue protein hydrolysate, and having a low salt content. It can be prepared by the desalting method according to the invention.

The animal feed supplement according to the invention generally comprises protein components originating from mucosa tissue, preferably from porcine mucosa tissue, even preferably from porcine mucosa tissue that has been enzymatically processed or hydrolyzed.

The animal feed supplement according to the invention has a low salt content or is free of salt, notably of salts selected in the list consisting of conservation salts and notably sodium, potassium, sulphite and sulphate salts, for example sodium chloride, sodium meta-bisulphite. According to the invention, the low content or the free salt content of the animal feed supplement means that the feed supplement according to the invention has a salt content that is significantly reduced or that the feed supplement is substantially free of any salt compared to the feed supplements known in the art. The animal feed supplement according to the invention can thus present an improved palatability to the animal and it can improve the feed intake of the animal as well as reduce the diarrhoea. It can additionally be administered in much higher dosage levels.

According to the invention, the animal feed supplement has a salt content below 30%, preferably below 25%, even preferably below 20% or 15% or even 10% or below.

In particular, the animal feed supplement according to the invention consists in a protein hydrolysate resulting from electro-dialysis desalting of a porcine mucosa and having a salt content below 30%, preferably below 25%, even preferably below 20% or 15% or even 10% or below. Advantageously, the animal feed supplement according to the invention consists in a protein hydrolysate resulting from electro-dialysis desalting of a porcine mucosa and being free of salt.

Within the animal feed supplement according to the invention, the respective content in protein components can vary in a large manner. Preferably, the animal feed supplement according to the invention generally comprises 60%, more preferably 80%, of its protein components having a size equal or less than 3 peptides. An example of a particular animal feed supplement according to the invention comprises protein components being 10% of polypeptides, 10% of oligo-peptides, 40% of di- and tri-peptides and 40% of free amino acids. Variations of these respective contents in protein components provides equivalent or similar alternatives of the animal feed supplement according to the invention.

Advantageously, the protein components of the animal feed supplement according to the invention have generally a molecular weight below 10,000 Dalton. The average size of the protein components is generally ranging from 100 to 4,000 Dalton, preferably from 200 to 1,000 Dalton, for example the average size can be 700 Dalton.

With low dry matter, the feed supplement according to the invention can be in the form of a powder that can be very fine.

The desalinated animal feed supplement according to the invention is generally stored in plastic-lined paper bags, for example at 20 to 25 kg filling degree, depending on bulk density. The invention also provides a feeding or growing method comprising feeding animals with the animal feed supplement according to the invention. In particular, the invention provides a feeding or growing method comprising feeding animals with an animal feed supplement consisting in a protein hydrolysate resulting from electro-dialysis desalting of a porcine mucosa and having a salt content below 30%, preferably below 25%, even preferably below 20% or 15% or even 10% or below, or that is free of salt. In case the feed supplement is free of salt, it can advantageously be used in a 100% dosage for feeding animals.

Except otherwise indicated for the present invention, the salt content referred to according to this invention relies on the protein hydrolysate according to the invention, the salt that might be present in the final feed or diet administered to the animal thus has another origin.

Even if the animal feed supplement according to the invention is particularly adapted for feeding a large number of animals like bovines, pork, goats, sheep, poultry, fish, dogs and pet animals; it is preferably used in growing pork, notably weaning piglets and lactating sows.

For example, the present invention provides a method for growing
weaning piglets, notably after 3-4 weeks of age, comprising feeding the animal with a diet including 2-3% of animal feed supplement according to the invention; or
lactating sows, notably to improve feed intake, comprising feeding the animal with a diet including 1-2% of animal feed supplement according to the invention; or
poultry, notably broilers and turkeys, comprising feeding the animal with a diet including 2-3% of animal feed supplement according to the invention; or
fish, notably salmon, trout and shrimp, comprising feeding the animal with a diet including 2-3% of animal feed supplement according to the invention; or
calf comprising feeding the animal with a diet including 2-3% of animal feed supplement according to the invention as a milk replacement; or
dogs or pet animals, notably animals necessitating hypo-allergenic diets or novel proteins, comprising feeding the animal with a diet including 1-2% of animal feed supplement according to the invention.

The following examples provide some illustrations of particular aspects of the invention. These examples also provides results and experimental data evidencing the efficiency of the invention compared to the prior art technologies.

### EXAMPLE 1

A solution of mucosa of porcine origin has been used in a electro-dialysis (ED) trial. Prior to ED trial, the mucosa has been centrifuged to remove the larger quantity of fat, and subsequent membrane filtration using ultrafiltration (UF) membranes with a cut-off of 10,000 Dalton (10 kDa). The UF permeate (with a recovery of 66% of the feed) was used as feed inlet of the ED unit. The permeate was cooled down to 40° C. as maximum inlet temperature for the ED unit.

For the ED trial the number of membranes is 41 corresponding to 20 cell pairs. The membrane area is 20×50 cm as useful surface and spacers made of polypropylene (PP) are used. The packing is made of polyvinylchloride (PVC) and the capacity of each liquid flow is 15 dm³/min with 2.2 meters of water column. The following settings were applied (40 V, 30 Ampere initial current). Over time samples of diluate were taken (see table 1) and were analysed on composition.

TABLE 1

| | initial | | | | | | | | | final |
|---|---|---|---|---|---|---|---|---|---|---|
| | composition | | | | | | | | | composition |
| | sample | | | | | | | | | |
| | diluate | | | | | | | | | |
| day 1 to day 2 | 8.45 h | 11.00 h | 13.00 h | 16.00 h | 18.20 h | 20.10 h | 03.00 h | 04.00 h | 06.00 h | 08.00 h |
| pH/° C. | 6.70/ | 6.86/ | 6.88/ | 6.89/ | 6.86/ | 6.84/ | 6.54/ | 6.58/ | 6.66/ | 6.68/ |
| | 24 | 24 | 24 | 24 | 24 | 24 | 24 | 24 | 24 | 24 |
| conductivity | 36.1/ | 29.4/ | 26.9/ | 23.4/ | 21.9/ | 21.9/ | 17.1/ | 15.2/ | 11.4/ | 8.94/ |
| (ms/cm)/T ° C. | 23.8 | 23.9 | 24.1 | 23.9 | 23.9 | 23.9 | 23.9 | 23.9 | 23.8 | 23.9 |
| dry matter (g/kg) | 136 | 114 | 114 | 100 | 97 | 95 | 78 | 78 | 76 | 74 |
| TKN | 13.97 | 12.32 | 12.10 | 11.87 | 11.70 | 11.52 | 10.72 | 10.66 | 10.41 | 10.05 |
| protein g/kg | 87.31 | 77.00 | 75.63 | 74.19 | 73.13 | 72.00 | 67.00 | 66.63 | 65.06 | 62.81 |
| (factor 6.25) | | | | | | | | | | |
| ash 825 (g/kg) | 34.3 | 27.7 | 24.0 | 19.3 | 17.3 | 16.4 | 8.9 | 7.4 | 5.1 | 5.4 |
| Na (g/kg) | 11.6 | 8.57 | 7.51 | 5.97 | 5.32 | 5.14 | 2.85 | 2.46 | 1.72 | 1.58 |
| Cl (g/kg) | 1.4 | 0.7 | 0.4 | 0.3 | 0.3 | 0.4 | 0.4 | 0.3 | 0.2 | 0.1 |
| SO₃ (g/kg) | 8.06 | 5.10 | 4.15 | 2.51 | 2.09 | 2.02 | 0.54 | 0.59 | 0.58 | 0.41 |
| SO₄ (g/kg) bruto | 21.45 | 16.03 | 14.07 | 10.54 | 9.62 | 9.28 | 4.58 | 3.89 | 3.03 | 2.46 |
| SO₄ (g/kg) netto | 11.78 | 9.91 | 9.09 | 7.54 | 7.11 | 6.86 | 3.93 | 3.18 | 2.34 | 1.97 |
| sum salts SO₃, | 34.45 | 25.30 | 21.98 | 16.81 | 15.24 | 14.82 | 7.83 | 6.65 | 4.95 | 4.14 |
| So₄, Na, Cl | | | | | | | | | | |
| delta (ash − | −0.1 | 2.4 | 2.0 | 2.5 | 2.1 | 1.6 | 1.1 | 0.8 | 0.2 | 1.3 |
| sum salts) | | | | | | | | | | |
| sum ash + | 122 | 105 | 100 | 93 | 90 | 88 | 76 | 74 | 70 | 68 |
| protein | | | | | | | | | | |

In table 2, the results are presented further to recalculation with respect to the dry product consisting in 100% dry matter.

TABLE 2

| | Sample | | | | | | | | | |
|---|---|---|---|---|---|---|---|---|---|---|
| | diluate | | | | | | | | | |
| | 8.45 h | 11.00 h | 13.00 h | 16.00 h | 18.20 h | 20.10 h | 03.00 h | 04.00 h | 06.00 h | 08.00 h |
| | Recalculated | | | | | | | | | |
| | As 100% | As 100% | As 100% | As 100% | As 100% | As 100% | As 100% | As 100% | As 100% | As 100% |
| | DM | DM | DM | DM | DM | DM | DM | DM | DM | DM |
| Time from t = 0 | t = 0 | t = 2 | t = 4 | t = 7 | t = 9 | t = 11 | t = 18 | t = 19 | t = 21 | t = 23 |
| | | (+¼) | (+¼) | (+¼) | (+½) | (+½) | (+¼) | (+¼) | (+¼) | (+¼) |
| | 0 | 2.25 | 4.25 | 7.25 | 9.5 | 11.5 | 18 | 19 | 21 | 23 |
| pH/° C. | 6.51/ | 6.60 | 6.65 | 6.69 | 6.77/ | 6.81 | 6.86 | 6.88/ | 6.79/ | 6.67/ |
| | 13.2 | | | | 11.8 | | | 11.8 | 24.5 | 24.2 |
| Conductivity | 34.1/ | 31.7/ | 29.9/ | 28.0/ | 25.0/ | 21.9/ | 19.5/ | 17.2/ | 13.9/ | 11.67/ |
| (mS/cm)/ | 15.2 | 14.4 | 15.1 | 15.2 | 14.1 | 13.5 | 15.2 | 14.5 | 23.1 | 23.2 |
| T ° C. | | | | | | | | | | |
| Dry Matter (%) | 100 | 100 | 100 | 100 | 100 | 100 | 100 | 100 | 100 | 100 |
| TKN | 10.3 | 10.8 | 10.6 | 11.9 | 12.1 | 12.1 | 13.7 | 13.7 | 13.7 | 13.6 |
| Protein % | 64.2 | 67.5 | 66.3 | 74.2 | 75.4 | 75.8 | 85.9 | 85.4 | 85.6 | 84.9 |
| (factor 6.25) | | | | | | | | | | |
| Ash 825 (%) | 25.2 | 24.3 | 21.1 | 19.3 | 17.8 | 17.3 | 11.4 | 9.5 | 6.7 | 7.3 |
| Na (%) | 8.5 | 7.5 | 6.6 | 6.0 | 5.5 | 5.4 | 3.7 | 3.2 | 2.3 | 2.1 |
| Cl (%) | 1.0 | 0.6 | 0.4 | 0.3 | 0.3 | 0.4 | 0.5 | 0.4 | 0.3 | 0.1 |
| SO₃ (%) | 5.9 | 4.5 | 3.6 | 2.5 | 2.2 | 2.1 | 0.7 | 0.8 | 0.8 | 0.6 |
| SO₄ (%) bruto | 15.8 | 14.1 | 12.3 | 10.5 | 9.9 | 9.8 | 5.9 | 5.0 | 4.0 | 3.3 |
| SO₄ (%) netto | 8.7 | 8.7 | 8.0 | 7.5 | 7.3 | 7.2 | 5.0 | 4.1 | 3.1 | 2.7 |
| sum salts | 25.33 | 22.19 | 19.28 | 16.81 | 15.72 | 15.60 | 10.04 | 8.53 | 6.51 | 5.59 |
| SO₃, SO₄, | | | | | | | | | | |
| Na, Cl (%) | | | | | | | | | | |
| Delta (ash − | −0.1 | 2.1 | 1.8 | 2.5 | 2.1 | 1.7 | 1.4 | 1.0 | 0.2 | 1.7 |
| sum salts) (%) | | | | | | | | | | |
| sum ash + | 90 | 92 | 87 | 93 | 93 | 93 | 97 | 95 | 92 | 92 |
| protein (%) | | | | | | | | | | |
| Desalination | 0% | 12% | 24% | 34% | 38% | 38% | 60% | 66% | 74% | 78% |
| percentage | | | | | | | | | | |

Conductivity of the mucosa solution versus time is presented in table 2.

Over time the protein content increases to values above 85%, from initial value of about 63%. Ash content steadily drops from almost 26% to less than 6%.

### EXAMPLE 2

A further experiment has been worked in similar manner as for example 1. The results with respect to the content of the diluate further to analysis versus time are presented in table 3.

TABLE 3

| | sample | | | | | | | | | | |
|---|---|---|---|---|---|---|---|---|---|---|---|
| | diluate | | | | | | | | | | |
| day 1-day 2 | 11.00 h | 12.00 h | 14.00 h | 17.00 h | 18.00 h | 19.00 h | 20.00 h | 21.00 h | 22.00 h | 23.00 h | 00.15 h |
| Description | t = 0 | t = 1 | t = 3 | t = 6 | t = 7 | t = 8 | t = 9 | t = 10 | t = 11 | t = 12 | t = 13 |
| pH/° C. | 6.51/ | 6.60 | 6.69 | 6.86 | 6.88/ | 6.79/ | 6.67/ | 6.54/ | 6.43 | 6.00 | 5.63 |
| | 13.2 | | | | 11.8 | 24.5 | 24.2 | 25.2 | | | |
| Conductivity | 34.1/ | 31.7/ | 28.0/ | 19.5/ | 17.2/ | 13.9/ | 11.67/ | 9.92/ | 9.11/ | 7.31/ | 6.25/ |
| (mS/cm)/° C. | 15.2 | 14.4 | 15.2 | 15.2 | 14.5 | 23.1 | 23.2 | 23.6 | 23.5 | 22.3 | 21.2 |
| Dry Matter (g/kg) | 127 | 124 | 119 | 107 | 104 | 99 | 96 | 93 | 92 | 88 | 87 |
| TKN | 13.58 | 13.48 | 13.34 | 12.85 | 12.66 | 12.44 | 12.25 | 12.00 | 11.92 | 11.65 | 11.53 |
| Protein g/kg | 84.88 | 84.25 | 83.38 | 80.31 | 79.13 | 77.75 | 76.56 | 75.00 | 74.50 | 72.81 | 72.06 |
| (factor 6.25) | | | | | | | | | | | |
| Ash 825 (g/kg) | 30.2 | 29.2 | 25.9 | 17.6 | 15.4 | 12.4 | 9.9 | 7.8 | 4.4 | 4.7 | 4.1 |
| Na (g/kg) | 10.6 | 9.62 | 8.45 | 5.67 | 5.04 | 3.99 | 3.24 | 2.61 | 2.31 | 1.74 | 1.38 |
| Cl (g/kg) | 1.5 | 1.2 | 0.1 | 0.0 | 0.0 | 0.0 | 0.1 | 0.0 | 0.0 | 0.0 | 0.0 |
| SO₃ (g/kg) | 7.6 | 6.49 | 5.50 | 2.64 | 2.00 | 1.33 | 0.95 | 0.79 | 0.70 | 0.52 | 0.44 |
| SO₄ (g/kg) bruto | 22.259 | 19.11 | 16.20 | 10.49 | 9.90 | 7.13 | 5.38 | 3.36 | 2.96 | 2.06 | 1.92 |
| SO₄ (g/kg) netto | 13.142 | 11.33 | 9.60 | 7.33 | 7.50 | 5.53 | 4.24 | 2.42 | 2.21 | 1.44 | 1.40 |
| sum salts | 34.36 | 29.93 | 24.75 | 16.16 | 14.94 | 11.12 | 8.72 | 5.97 | 5.27 | 3.80 | 3.30 |
| SO₃, SO₄, | | | | | | | | | | | |
| Na, Cl | | | | | | | | | | | |
| Delta (ash − | −4.2 | −0.7 | 1.1 | 1.4 | 0.5 | 1.3 | 1.2 | 1.8 | −0.9 | 0.9 | 0.8 |
| sum salts) | | | | | | | | | | | |
| sum ash + | 119 | 113 | 109 | 98 | 95 | 90 | 86 | 83 | 79 | 78 | 76 |
| protein | | | | | | | | | | | |

### EXAMPLE 3

A further experiment has been worked in similar manner as for example 1. The results with respect to the content of the diluate further to analysis versus time are presented in table 4. The results have been generated by working the process according to the invention on a lab scale test with commercial test equipment.

TABLE 4

| | sample | | | | | | |
|---|---|---|---|---|---|---|---|
| | test 1 | | test 2 | | | reduction feed- | |
| | final | final | | final | final | final diluate | |
| Description | diluate | concentrate | feed | diluate | concentrate | g/kg | % |
| pH/° C. | 8.47/ | 9.03/ | 8.85/ | 8.33/ | 8.98/ | | |
| | 13.2 | 13.5 | 13.7 | 13.3 | 13.4 | | |
| Conductivity | 7.44/ | 48.7/ | 35.7/ | 8.08/ | 51.1/ | | |
| (mS/cm)/° C. | 14.0 | 14.2 | 14.5 | 14.1 | 14.3 | | |
| Dry Matter (g/kg) | 79 | 83 | 120 | 75 | 92 | 45 | 38 |
| TKN | 10.9 | 6.0 | 13.5 | 10.7 | 7.9 | 3 | 21 |
| Protein g/kg | 68.1 | 37.6 | 84.3 | 66.8 | 49.1 | 17 | 21 |
| (factor 6.25) | | | | | | | |
| Ash 825 (g/kg) | 4.1 | 37.8 | 24.4 | 3.5 | 36.1 | 21 | 86 |
| Na (g/kg) | 2.1 | 16.9 | 12.9 | 1.8 | 18.0 | 11 | 86 |
| Cl (g/kg) | | | | | | | |
| SO₃ (g/kg) | 0.2 | 11.6 | 3.6 | 0.1 | 9.8 | 4 | 98 |
| SO₄ (g/kg) gross | 0.5 | 20.1 | 13.6 | 0.3 | 19.6 | 13 | 98 |
| SO₄ (g/kg) nett | 0.3 | 6.1 | 9.3 | 0.2 | 7.8 | 9 | 98 |
| sum salts | 2.6 | 37.0 | 26.5 | 2.1 | 37.6 | | |
| SO₃, SO₄, | | | | | | | |
| Na, Cl | | | | | | | |
| Delta (ash − | 1.5 | 0.8 | −2.1 | 1.4 | −1.5 | | |
| sum salts) | | | | | | | |
| sum ash + | 71 | 75 | 109 | 70 | 85 | | |
| protein | | | | | | | |

TABLE 5

| | | final | | | final |
|---|---|---|---|---|---|
| | final | concen- | | final | concen- |
| | diluate | trate | feed | diluate | trate |
| Recalculated | As | As | As | As | As |
| | 100% | 100% | 100% | 100% | 100% |
| | D.S. | D.S. | D.S. | D.S. | D.S. |
| Conductivity | 7.44/14.0 | 48.7/14.2 | 35.7/14.5 | 8.08/14.1 | 51.1/14.3 |
| (mS/cm)/ | | | | | |
| ° C. | | | | | |
| Dry Matter | 100 | 100 | 100 | 100 | 100 |
| (%) | | | | | |
| TKN | 13.8 | 7.2 | 11.2 | 14.3 | 8.5 |
| Protein % | 86.2 | 45.3 | 70.2 | 89.1 | 53.4 |
| (factor 6.25) | | | | | |
| at 825° C. | 5.2 | 45.5 | 20.3 | 4.7 | 39.2 |
| (%) | | | | | |
| Na (%) | 2.7 | 20.4 | 10.8 | 2.4 | 19.6 |
| Cl (%) | 0.0 | 0.0 | 0.0 | 0.0 | 0.0 |
| SO₃ (%) | 0.2 | 14.0 | 3.0 | 0.1 | 10.7 |
| SO₄ (g/kg) | 0.6 | 24.2 | 11.3 | 0.4 | 21.3 |
| gross | | | | | |
| SO₄ (g/kg) | 0.3 | 7.4 | 7.7 | 0.3 | 8.5 |
| nett | | | | | |
| sum salts | 3.3 | 44.6 | 22.1 | 2.8 | 40.9 |
| SO₃, SO₄, | | | | | |
| Na, Cl (%) | | | | | |
| Delta | 1.9 | 1.0 | −1.7 | 1.9 | −1.6 |
| (ash - sum | | | | | |
| salts) (%) | | | | | |
| sum ash + | 89.5 | 90.8 | 90.5 | 93.8 | 92.6 |
| protein (%) | | | | | |
| Desalination | 87% | −68% | | 89% | −54% |
| percentage | | | | | |

### EXAMPLE 4

A further experiment has been worked in similar manner as for example 1. The voltage, current characteristics of the industrial scale pilot with electro-dialysis are presented in table 6. Conductivity of both diluate and concentrate are monitored over time and presented in table 7. A decrease in diluate conductivity has been observed as well as an increase in concentrate conductivity.

TABLE 6
Industial Pilot Test Batch 1
Volume 110 L- 10% dry matter inlet concentration

| | | Diluate | | | | Concentrate | | | Electrolyte |
|---|---|---|---|---|---|---|---|---|---|
| | Voltage | Current | Conductivity | Qᵥ | T | Conductivity | Qᵥ | T | Qᵥ |
| Time | (V) | (Amp.) | (mS/cm) | (ltr/hr) | (° C.) | (mS/cm) | (ltr/hr) | (° C.) | (ltr/hr) |
| 9:00 | 35 | 20 | 26.7 | 900 | 33 | 21.8 | 1000 | 38 | 750 |
| 9:20 | 35 | 24 | 25.2 | 900 | 33 | 28.8 | 1000 | 38 | 750 |
| 10:00 | 35 | 24 | 22.5 | 900 | 33 | 35.5 | 1000 | 38 | 750 |
| 10:15 | 35 | 23.8 | 21.6 | 1000 | 33 | 37.6 | 1000 | 38 | 750 |
| 10:50 | 35 | 21 | 17.6 | 1000 | 33 | 40.8 | 1000 | 38 | 710 |
| 11:30 | 35 | 18 | 14.9 | 1000 | 33 | 42.4 | 1000 | 38 | 710 |
| 12:30 | 35 | 12 | 10.5 | 1000 | 33 | 43.7 | 1000 | 38 | 710 |
| 13:15 | 35 | 9 | 8.4 | 1000 | 33 | 44.1 | 1000 | 38 | 710 |
| 13:45 | 35 | 7.4 | 7.3 | 1000 | 33 | 44.2 | 1000 | 38 | 710 |

TABLE 7
volume 200 L 20% dry matter at inlet ED unit

| | | | Diluate | | | Concentrate | | | Electrolyte |
|---|---|---|---|---|---|---|---|---|---|
| | Voltage | Current | Conductivity | Qv | T | Conductivity | Qv | T | Qv |
| Time | (V) | (Amp.) | (mS/cm) | (ltr/hr) | (° C.) | (mS/cm) | (ltr/hr) | (° C.) | (ltr/hr) |
| D 1 | 35 | 17 | 54.9 | 900 | 37 | 33.8 | 1000 | 40 | 750 |
| 18:00 | | | | | | | | | |
| 18:05 | 35 | 22 | 45.7 | 900 | 37 | 42.4 | 1000 | 40 | 750 |
| 18:15 | 35 | 25 | 41.3 | 900 | 37 | 55.2 | 1000 | 40 | 750 |
| 22:00 | 35 | 25 | 36.7 | 1000 | 37 | 42.4 | 1000 | 40 | 750 |
| D 2 | 35 | 18 | 19 | 1000 | 37 | 44.6 | 1000 | 40 | 680 |
| 8:15 | | | | | | | | | |
| 11:45 | 35 | 10 | 13.9 | 1000 | 37 | 52 | 1000 | 40 | 680 |
| 12:40 | 35 | 9.2 | 12.7 | 1000 | 37 | 52.8 | 1000 | 40 | 680 |
| 12:55 | 35 | 9 | 12.8 | 1000 | 37 | 52.9 | 1000 | 40 | 680 |

In table 8, feed inlet corresponds to the untreated mucosa and diluates 1 and 3 are examples of desalted mucosa compositions. It can be clearly seen that the protein/dry matter content increases to values over 80%. Ash content is reduced from almost 30% in the dry matter to less than 10% in the dry matter. Also clear reduction of salt-ions has been observed (chlorine, sodium, sulphite and sulphate).

TABLE 8

| | sample | | |
|---|---|---|---|
| | feed | diluate | diluate |
| | inlet | batch 1 | batch 3 |
| | day 1 | day 14 | day 16 |
| pH/° C. | 6.76/17.3 | 6.42/17.2 | 6.51/17.3 |
| Conductivity (mS/cm)/° C. | 28.0/17.8 | 6.5/17.9 | 19.0/17.8 |
| Dry matter (g/kg) | 90 | 47 | 171 |
| TKN | 8.9 | 6.2 | 22.9 |
| protein g/kg (factor 6.25) | 55.6 | 39.0 | 143.3 |
| Protein/dry matter | 62% | 83% | 84% |
| ash 825° C. (g/kg) | 25.8 | 5.0 | 11.7 |
| ash 825° C./dry matter (%) | 28.7% | 10.6% | 6.8% |
| ash 550° C. (g/kg) | 26.4 | 3.9 | 12.8 |
| ash 550° C./Dry matter (%) | 29.3% | 8.3% | 7.5% |
| Na (g/kg) | 9.1 | 1.5 | 4.5 |
| Cl (g/kg) | 1.1 | 0.1 | 0.3 |
| SO₃ (g/kg) | 2.9 | 0.2 | 0.4 |
| SO₄ (g/kg) bruto | 16.3 | 2.3 | 6.3 |
| SO₄ (g/kg) netto | 12.8 | 2.1 | 5.8 |
| sum salts SO₃, SO₄, Na, Cl | 25.9 | 3.9 | 11.0 |
| ash-sum other salts | 0.5 | 0.0 | 1.8 |
| sum ash 550 + protein | 82 | 43 | 156 |
| sum ash 825 + protein | 81 | 44 | 155 |

### EXAMPLE 5

A further experiment has been worked starting from an aminoacid composition analysis before and further to electro-dialysis. Results obtained from pilot plant scale tests are presented in table 9.

A known commercial product (Palbio) has been used as e reference. Proglobulin a protein derived from blood plasma and known to be used for similar feed application has been used as a further reference.

TABLE 9

| | 80% | | | 80% | | | |
|---|---|---|---|---|---|---|---|
| | desalted | Existing | | desalted | Existing | | Proglobulin |
| aminoacids: | ED trial | Mucosa | Palbio | ED trial | Mucosa | Palbio | 80P |
| Cysteïne (g/kg) | 5.5 | 7.5 | 6.1 | 0.7% | 1.4% | 1.1% | 3.6% |
| Hydroxyproline (g/kg) | 5.2 | <0.5 | 9.7 | 0.7% | | 1.7% | 0.0% |
| Methionine (g/kg) | 11.4 | 11.5 | 11.8 | 1.5% | 2.1% | 2.1% | 0.7% |
| Asparagine (g/kg) | 52.0 | 53.3 | 49.4 | 7.0% | 9.6% | 8.8% | 9.1% |
| Threonine (g/kg) | 40.1 | 26.5 | 25.0 | 5.4% | 4.8% | 4.5% | 5.4% |
| Serine (g/kg) | 33.5 | 27.3 | 24.8 | 4.5% | 4.9% | 4.4% | 5.2% |
| Glutamic acid (g/kg) | 81.4 | 82.9 | 75.3 | 11.0% | 14.9% | 13.5% | 13.2% |
| Proline (g/kg) | 51.0 | 34.0 | 35.4 | 6.9% | 6.1% | 6.3% | 5.5% |
| Glycine (g/kg) | 53.1 | 37.6 | 55.7 | 7.2% | 6.7% | 10.0% | 3.3% |
| Alanine (g/kg) | 55.1 | 37.6 | 34.1 | 7.4% | 6.7% | 6.1% | 5.1% |
| Valine (g/kg) | 52.3 | 35.2 | 30.4 | 7.1% | 6.3% | 5.4% | 6.3% |
| Iso-Leucine (g/kg) | 35.2 | 25.0 | 23.3 | 4.7% | 4.5% | 4.2% | 3.4% |
| Leucine (g/kg) | 64.6 | 46.1 | 43.4 | 8.7% | 8.3% | 7.8% | 9.1% |
| Tyrosine (g/kg) | 34.4 | 18.9 | 19.7 | 4.6% | 3.4% | 3.5% | 6.1% |
| Phenylalanine (g/kg) | 36.0 | 23.6 | 21.4 | 4.9% | 4.2% | 3.8% | 5.4% |
| Histidine (g/kg) | 20.6 | 10.9 | 12.1 | 2.8% | 2.0% | 2.2% | 3.1% |
| Lysine (g/kg) | 64.5 | 46.9 | 47.3 | 8.7% | 8.4% | 8.5% | 8.5% |
| Arginine (g/kg) | 38.5 | 25.8 | 31.2 | 5.2% | 4.6% | 5.6% | 5.5% |
| Tryptophan (g/kg) | 6.5 | 6.6 | 3.5 | 0.9% | 1.2% | 0.6% | 1.5% |
| free amino acids | 740 | 557 | 559 | 100% | 100% | 100% | 100% |

1-15. (canceled)

16. A method for the preparation of an animal feed or pet food supplement, wherein the feed or supplement comprises bovine or porcine mucosa, comprising:
i) enzymatically processing or hydrolyzing mucosa tissue of a bovine or porcine,
ii) extracting heparin from the mucosa tissue obtained from step (i),
iii) recovering a hydrolysate comprising hydrolyzed proteins or parts thereof having a molecular weight equal to or less than 10 kDa; and
iv) desalting the hydrolysate obtained from step (iii) utilizing electro-dialysis.

17. The method of claim 16, wherein the hydrolysate comprises proteins in residual or reduced amounts selected from the group consisting of polypeptides, oligopeptides, di-peptides, tri-peptides, and free amino acids

18. The method of claim 16, wherein the hydrolysate comprises about 10% polypeptides, about 10% oligopeptides, about 40% of di- and tri-peptides, and about 40% free amino acids.

19. The method of claim 16, wherein desalting the hydrolysate comprises removal of a salt selected from the group consisting of sodium, potassium, sulphite, sulphate, sodium chloride, and sodium meta-bisulphite.

20. The method of claim 16, wherein electro-dialysis reduces the salt content of the hydrolysate by 50%.

21. The method of claim 16, further comprising concentrating the hydrolysate obtained after step (iii) so as to reduce the water content of the hydrolysate by 50% prior to desalting the hydrolysate.

22. An animal feed or pet food supplement prepared according to the method of claim 16.

23. An animal feed or pet food supplement comprising enzymatically processed or hydrolyzed mucosa tissue, wherein the mucosa tissue contains a salt content below 30%.

24. The animal feed or pet food supplement of claim 23, wherein the mucosa tissue contains a salt content below 10%.

25. The animal feed or pet food supplement of claim 23, wherein the enzymatically processed or hydrolyzed mucosa tissue is desalted to remove at least one salt selected from the group consisting of sodium, potassium, sulphite, sulphate, sodium chloride, and sodium meta-bisulphite.

26. The animal feed or pet food supplement of claim 23, wherein the mucosa tissue is obtained from a bovine or a porcine.

27. The animal feed or pet food supplement of claim 26, wherein a hydrolysate is recovered from the enzymatically processed or hydrolyzed mucosa tissue, wherein the hydrolysate comprises hydrolyzed proteins or parts thereof having a molecular weight equal to or less than 10 kDa.

28. The animal feed or pet food supplement of claim 27, wherein the hydrolysate comprises about 10% polypeptides, about 10% oligopeptides, about 40% of di- and tri-peptides, and about 40% free amino acids.

29. The animal feed or pet food supplement of claim 27, wherein the hydrolysate comprises hydrolyzed proteins or parts thereof having an average size of between 200 to 1,000 Dalton.

30. The animal feed or pet food supplement of claim 25, wherein electro-dialysis is utilized to desalt the enzymatically processed or hydrolyzed mucosa tissue.

31. A method for growing or feeding an animal comprising feeding the animal an animal feed or pet food supplement comprising enzymatically processed or hydrolyzed mucosa tissue, wherein the mucosa tissue contains a salt content below 30%.

32. The method of claim 31, wherein the animal feed or pet food supplement comprises 1-3% of the animals total diet.

33. The method of claim 31, wherein the animal is selected from the group consisting of a weaning piglet of 3-4 weeks of age, a lactating sow; a fish, a pet animal, a calf, and a bird.

34. The method of claim 33, wherein the animal is a lactating sow and wherein the animal feed or pet food supplement comprises 1-2% of the sow's total diet.

35. The method of claim 33, wherein the animal is a pet animal in need of a hypo-allergenic diet, and wherein the animal feed or pet food supplement comprises 1-2% of the animal's total diet.
